(19) United States
(12) Patent Application Publication
(10) Pub. No.: US 2009/0125564 A1
(43) Pub. Date: May 14, 2009

(54) METHOD OF CONTROLLING USER ACCESS TO MULTIPLE SYSTEMS

(76) Inventors: Robert E. Walsh, San Mateo, CA (US); Paul Van Loon, Danville, CA (US)

Correspondence Address: Visa USA c/o Duane Morris LLP;Attn: James Sze, Esq., 101 West Broadway, Suite 900, San Diego, CA, 92101, US

(21) Appl. No.: 11/938,951

(22) Filed: Nov. 13, 2007

(51) Int. Cl. G06F 12/00; G06F 17/30

(52) U.S. Cl. 707/200; 707/E17.005

(57) ABSTRACT

A method of managing controlled user access to multiple subsystems in an enterprise system having a central directory containing a global user list of end-users and one or more netgroup lists defining a list of authorized end-users for accessing certain subsystem enables automatic update of one or more netgroup lists whenever an end-user's security access information in the global user list is updated by the system administrator.

### CROSS-REFERENCE TO RELATED APPLICATIONS

### None

### FIELD OF THE INVENTION

Aspects of the present invention relate generally to systems and methods of managing user access to multiple subsystems in a computer system.

### BACKGROUND INFORMATION

In an enterprise computer system, a plurality of end-users may access the system. For security reasons, the enterprise computer system maintains a list of the known or registered end-users so that only the registered end-users can access the system. Furthermore, each end-user is required to authenticate his or her identity when accessing the system by going through an authenticating log-in process. Such authenticating log-in process can be very elaborate, but at a minimum typically requires the user to present a log-in ID and a password. In a typical enterprise computer system, an end-user would access the computer system via a terminal that may be connected to the computer system either locally or remotely. The connection can be established either by hardwire or wirelessly.

In a large enterprise computer system, where the computer system comprises multiple subsystems or servers networked through a central server, each subsystem can support different applications and each subsystem can have different list of registered end-users. In a conventional enterprise system, the provisioning or end-user access privilege management with respect to each subsystem is enabled by maintaining a separate database of registered end-users for each subsystem at each subsystem. Each such database contains a list of end-users and their associated identity authentication data, i.e. credentials such as log-in ID and password. However, having the authentication data dispersed in various subsystems is costly and cumbersome to manage.

In more recently developed systems, a single instance of an end-user identity is maintained in a central directory by adding the end-user's name and authentication data to a global user list in the central directory. Thus, the global user list contains a list of all known end-users and each end-user's authentication data such as log-in ID and password. As such, a user who logs into the central directory from a server will have access to that server and any other such server which are similarly configured. The need may arise to restrict user access to a limited subset of such servers. This need can be addressed by the use of netgroups.

A set of sub-lists, called netgroup lists, is also maintained in the central directory by adding the end-user's name to one or more netgroup lists in the central directory. Then, each netgroup list is associated to one or more of the multiple sub-systems or servers in the computer system. Each end-user in the global user list is assigned to one or more netgroup lists, whereby authorization of the end-users' access to the multiple sub-systems is managed by adding or deleting a user name to or from the netgroup lists. Because the end-user authentication data is stored in the global user list only, when an end-user's authentication data is changed, only the global user list has to be updated. However, if the end-user's security access information changes, the appropriate netgroup lists have to be manually updated. The Tivoli Identity Manager and Directory server system available from IBM Corporation of Armonk, N.Y. is an example of such conventional user access management system.

### SUMMARY OF THE INVENTION

According to an embodiment, a method of managing controlled user access to multiple sub-systems or servers within a computer system or a network such as an enterprise system is disclosed. The enterprise system comprises a central directory containing: 1) a global user list containing end-users and their associated security access information, and 2) one or more netgroup lists where each netgroup list represents a list of end-users that are authorized to access one or more of the multiple subsystems. The novel method comprises automatically updating the one or more netgroup lists, by adding or deleting appropriate user identities, when an end-user's security access information and/or identity information in the global user list is updated such as by a system administrator.

According to another embodiment of the invention, a computer-readable medium, encoded with data and instructions for a user access management system is disclosed. When executed by an enterprise system, the instructions cause the enterprise system to automatically update the one or more netgroup lists corresponding to the updated end-user's security access information whenever an end-user's security access information in the global user list is updated.

Unlike any conventional user access management systems, the method and system disclosed herein provides an enterprise system with the benefit of centrally managed user access management (i.e. provisioning) at a central directory server while allowing ease of maintaining end-user identity data and flexibility of managing end-user access authorization to multiple subsystems of different types.

The system and method disclosed herein allows for the implementation of a user access management system that is vendor and product independent such that the system can be implemented across a plurality of heterogeneous subsystems, each subsystem running different operating platforms. The system and method is scalable to any number of subsystems networked in an enterprise system and any number of end-users accessing the subsystems.

### BRIEF DESCRIPTION OF THE DRAWINGS

FIG. 1 is a schematic conceptual illustration of the global user list and the netgroup lists maintained in the central directory of the enterprise system according to an embodiment.

FIG. 2 is a schematic conceptual illustration showing how the use of the global user list and the netgroup lists in the central directory manages access to various subsystems.

FIG. 3 is a schematic illustration of an enterprise system according to an embodiment.

FIG. 4 is a flowchart illustrating the method according to an embodiment.

### DETAILED DESCRIPTION

An aspect of the invention is an improved method of managing the access, authentication, and administration of end-user access to an enterprise system.

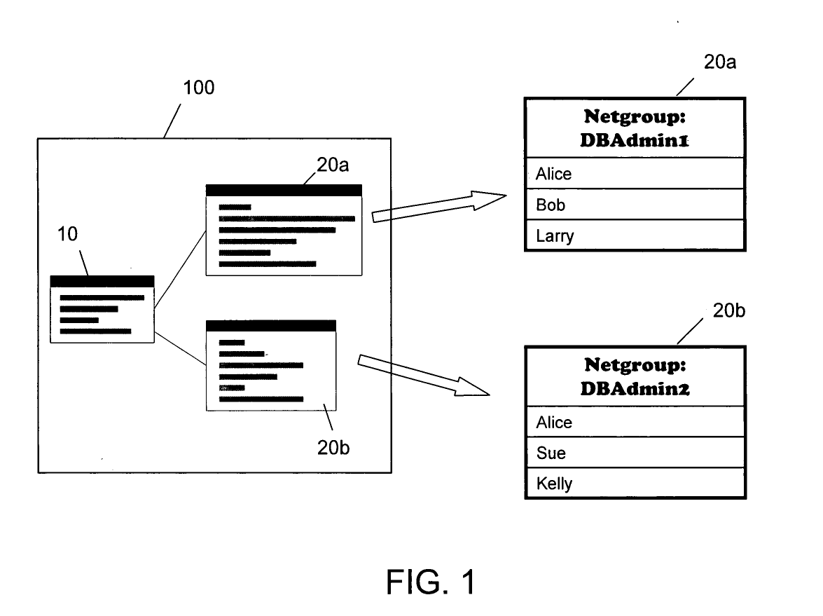

Referring to FIG. 1, an aspect of the invention is creating a single instance of an end-user identity in a central directory 100 by adding the end-user's name and authentication data to a global user list 10 in the central directory. The central directory 100 is stored in a central directory server of the enterprise system. The end-user's authentication data can include such identifying parameters as the end-user's log-in ID and password, for example, but depending on the needs of the enterprise system, the authentication data can include any other appropriate parameters that are selected to be used for such purpose. Other examples are biometric parameters such as retinal scan data or fingerprint data. In any event, the global user list 10 maintained in the central directory represents a single instance of an end-user's identity.

One or more sub-lists, called netgroup lists are also maintained in the central directory 100. Each of the netgroup lists represents a subset of the list of end-users in the global user list 10 who are authorized to access one or more subsystems that have been designated to be associated with the particular netgroup list. According to an aspect, each netgroup list can be associated with more than one subsystem and each subsystem can be associated with more than one netgroup list. Each netgroup list represents a list of users that are authorized to access one or more particular subsystems. Thus, each of the end-users whose authentication data is on the global user list 10 is on one or more netgroup lists. Netgroup lists contain the end-user's log-in ID. Two such netgroup lists 20a and 20b are shown. The netgroup lists can be labeled with any suitable name and can contain any number of end-users.

Then, each netgroup list is associated to one or more of the multiple sub-systems or servers in the computer system. The association between a netgroup list and subsystems can be accomplished by an appropriate software at each of the subsystems so that the subsystem maintains the name(s) of the netgroup lists that contain the end-users that are approved for accessing the subsystem. When an end-user attempts to log-in to one of the subsystems by entering his or her log-in ID and a password, typically using a remote terminal connected to the subsystem, the subsystem checks the netgroup list(s) that are associated to it to verify that the log-in ID entered by the end-user is on the netgroup list. If the end-user's name is found on one of the netgroup list(s) associated with the sub-system, that end-user is authorized to access the subsystem and the subsystem will then authenticate the end-user's identity using the end-user's authentication data, the log-in ID and the password. The subsystem accesses the global user list 10 in the central directory and compare the authentication data entered by the end-user to that stored in the global user list 10.

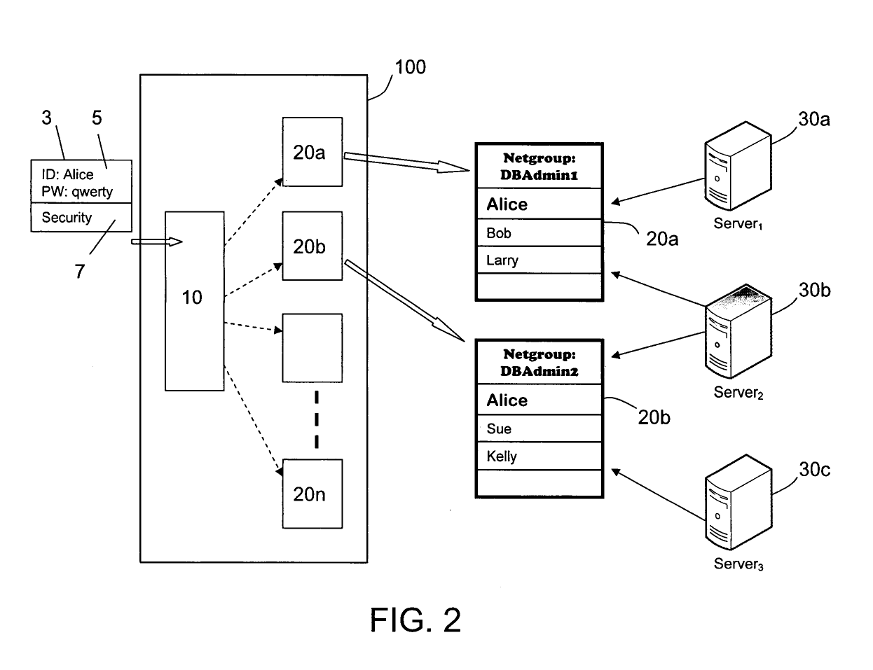

Referring to FIG. 2, the central directory 100 contains the global user list 10. The end-users in the global user list are assigned to one or more of the multiple netgroup lists 20a, 20b, . . . 20n which are, in turn, associated with one or more subsystems. In the illustrated example, the netgroup list 20a is associated with subsystems 30a and 30b. The subsystems can be a plurality of heterogeneous systems running different operating system platforms, e.g. UNIX/Linux, AIX, Solaris, RedHat4 Linux, etc. The netgroup list 20b is associated with subsystems 30b and 30c. The netgroup list 20a includes end-users Alice, Bob and Larry and the netgroup list 20b includes end-users Alice, Sue and Kelly. In this example, Alice is authorized to access all three subsystems 30a, 30b, 30c and, thus, is listed in both netgroup list 20a and 20b. Bob and Larry who are only listed in the netgroup list 20a are only authorized to access subsystems 30a and 30b. Sue and Kelly who are only listed in the netgroup list 20b are only authorized to access subsystems 30b and 30c. As shown in this example, multiple subsystems can be associated to a same netgroup list. The central directory 100 can be maintained on a lightweight directory access protocol (LDAP) directory server to which the subsystems are networked over the Internet.

An end-user may be authorized to access more than one subsystem. Thus, each end-user in the global user list can be assigned to one or more netgroup lists. If any of the end-user access authorization information changes, the system administrator updates the global user list 10 appropriately. For example, end-users may need to be removed from or added to the global user list 10, the end-users' authentication data may need to be updated. In some instances, the end-user may have changed the log-in password or the end-user's security access information will need to be updated when the end-user's authorizations to access the subsystems change. In the conventional enterprise system environments, when the end-user's security access information changes, the system administrator had to update the global user list 10 and also manually update the netgroup lists appropriately. This takes up the system administrator's time and increases the opportunity for human errors because the system administrator has to manually update the affected netgroup list(s).

According to an aspect of the invention, the maintenance of the netgroup lists is automatically executed by the enterprise system appropriately configured with a user access management system software/firmware whenever the end-users' security access information is updated on the global user list 10. The end-users' security access information may be updated by a system administrator manually or alternatively may be updated automatically on schedule by the system. For example, referring to FIG. 2, when the system administrator adds a new user identity 3 Alice to the global user list 10 with an authentication data (log-in ID: Alice, password: qwerty) 5 and a security access information 7, the user access management system automatically updates the appropriate netgroup lists with Alice's log-in ID. In the example of FIG. 2, Alice's security access information 7 identifies that Alice is authorized to access subsystems Server₁ 30a, Server₂ 30b and Server₃ 30c. Thus, the user access management system automatically updates the netgroup lists 20a and 20b with Alice's log-in ID information. So, subsequently, when Alice tries to log on to subsystem 30c, the subsystem accesses netgroup list “DBAdmin2” 20b in the central directory 100 to check whether Alice's log-in ID is on the netgroup list.

In another example, if Alice's security access gets limited to Server₁ 30a only, the system administrator would update Alice's security access information 7 in the global user list 10 appropriately. The user access management system will then automatically remove Alice's log-in ID information from the netgroup list “DBAdmin2” 20b.

Because the global user list 10 and the netgroup lists 20a, 20b are all stored and maintained in the central directory 100 and only one copy of the end-users' identities is required in the global user list 10, the system and method disclosed herein simplifies the administration of user access management. Regardless of the number of subsystems a particular end-user is authorized to access, by the system administrator updating the entry for that end-user on the global user list 10, all associated netgroup lists are automatically updated.

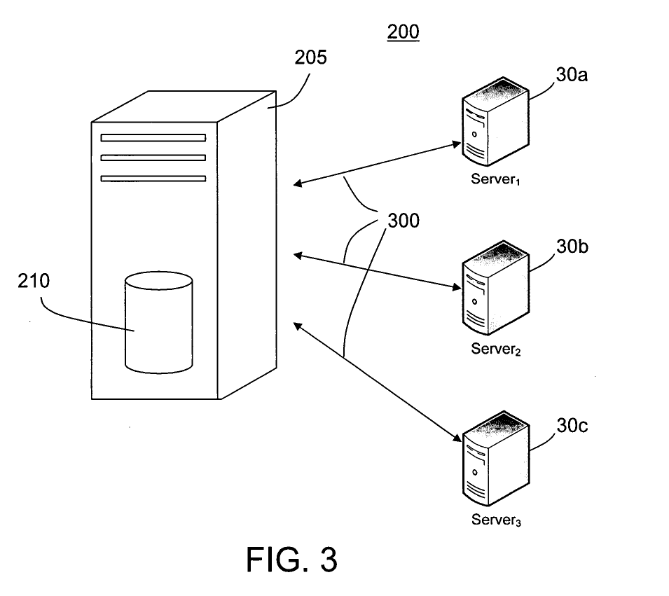

FIG. 3 shows a schematic illustration of an enterprise system 200 incorporating the end-user access management system described herein according to an embodiment of the invention. The enterprise system comprises a central server 205 that is networked with a plurality of subsystems. In this illustrated example, three subsystems 30a, 30b and 30c are shown. As mentioned above, the subsystems can be a plurality of heterogeneous systems and the enterprise system 200 is configured to seamlessly communicate with these subsystems. The network connections 300 can be wired or wireless connections and can be through LAN, WAN, or the Internet. The central server 205 includes a storage unit 210 where the central directory 100 is maintained.

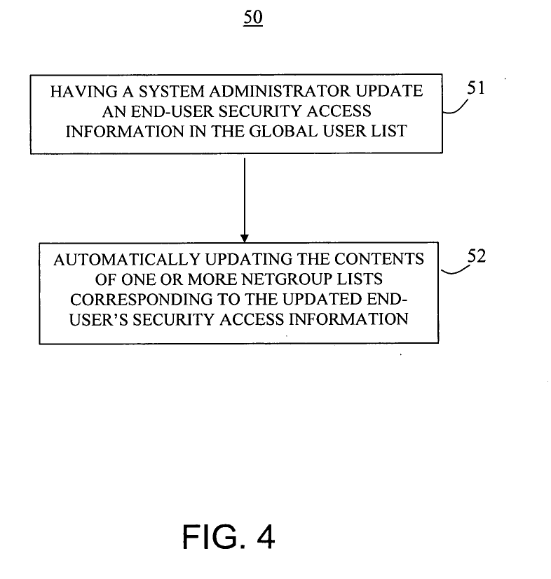

FIG. 4 shows a flowchart 50 describing the method of managing controlled end-user access to multiple subsystems in an enterprise system. According to the method, a system administrator updates an end-user's security access information in the global user list, block 51. Then, the enterprise system's user access management system automatically updates the contents of one or more corresponding netgroup lists according to the updated end-user security access information, block 52.

A benefit of the system and method described herein is that the standard object definitions such as posixaccount, posixgroup and nisNetgroups are utilized for the provisioning of user identity and authentication for managing security access in a computer network. This enables the method and system to be scalable to handle as many heterogeneous subsystems as necessary. This also enables the method to be implemented on a variety of centralized directories and identity management systems.

The user access management system and method described herein can be implemented in conjunction with any provisioning applications in existing enterprise systems and any type of servers and directory servers. The user access management system can be provided as software recorded on an appropriate computer-readable medium readable by the enterprise system's central server. The user access management system also can be provided as a firmware.

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

What is claimed is:

1. A computer-implemented method of managing controlled user access to multiple subsystems in an enterprise system wherein the enterprise system comprises: a central directory comprising a global user list, the global user list comprising a list of end-users and associated security access information, and one or more netgroup lists wherein each netgroup list is associated with one or more of the multiple subsystems and each netgroup list comprises a list of end-users that are authorized to access the one or more of the multiple subsystems, the method comprising:
having a system administrator update an end-user's security access information in the global user list; and
automatically updating the contents of one or more netgroup lists corresponding to the updated end-user's security access information.

2. The method of claim 1, wherein the security access information comprises information regarding which subsystem the end-user is authorized to access.

3. The method of claim 1, wherein the netgroup lists comprises a list of the authorized end-users' log-in IDs.

4. A computer-readable medium, encoded with data and instructions, such that when executed by an enterprise system, the instructions cause the enterprise system to:
automatically update one or more netgroup lists whenever at least one end-user's security access information in the global user list is updated, the one or more netgroup lists corresponding to the one or more end-users' updated security access information.

5. The computer-readable medium of claim 4, wherein the end-user's security access information comprises information regarding which subsystem the end-user is authorized to access.

6. The computer-readable medium of claim 4, wherein the end-user's security access information is updated by a system administrator.

7. The computer-readable medium of claim 4, wherein the enterprise system comprises a central directory comprising a global user list, the global user list comprising a list of end-users and associated security access information, and one or more netgroup lists wherein each netgroup list is associated with one or more of the multiple subsystems and each net group list comprises a list of end-users that are authorized to access the one or more of the multiple subsystems.

8. An enterprise system comprising:
a central server connected to multiple subsystems;
a central directory maintained on the central server, the central directory comprising a global user list, the global user list comprising a list of end-users and associated security access information, and one or more netgroup lists wherein each netgroup list is associated with one or more of the multiple subsystems and each net group list comprises a list of end-users that are authorized to access the one or more of the multiple subsystems; and
a user access management system configured to automatically update the contents of one or more netgroup lists whenever an end-user's security access information in the global user list is updated, the update to the contents of one or more netgroup lists corresponding to the updated end-user's security access information.

9. The enterprise system of claim 8, wherein the security access information comprises information regarding which subsystem the end-user is authorized to access.

10. The enterprise system of claim 8, wherein the netgroup lists comprises a list of the authorized end-users' log-in IDs.
